(19) United States
(12) Patent Application Publication
(10) Pub. No.: US 2014/0263415 A1
(43) Pub. Date: Sep. 18, 2014

(54) Flavored Frozen Beverage Dispenser

(71) Applicant: The Coca-Cola Company, Atlanta, GA (US)

(72) Inventors: Rafael I. San Miguel, Atlanta, GA (US); Arthur G. Rudick, Atlanta, GA (US)

(21) Appl. No.: 14/210,933

(22) Filed: Mar. 14, 2014

Related U.S. Application Data
(60) Provisional application No. 61/863,991, filed on Aug. 9, 2013.
(60) Provisional application No. 61/792,260, filed on Mar. 15, 2013.

(51) Int. Cl. A23G 9/04; A23G 9/28

(52) U.S. Cl. CPC A23G 9/045; A23G 9/28
USPC 222/1; 222/148

(57) ABSTRACT

Embodiments of the invention may provide a frozen beverage dispenser capable of dispensing multiple frozen beverage flavors.

### CROSS-REFERENCE TO RELATED APPLICATIONS

This patent application claims priority to U.S. Patent Application Ser. No. 61/792,260, Attorney Docket No. 60428.0012USP1, filed Mar. 15, 2013, entitled “Flavored Frozen Beverage Dispenser” and U.S. Patent Application Ser. No. 61/863,991, Attorney Docket No. 60428.0012USP2, filed Aug. 9, 2013, entitled “Flavored Frozen Beverage Dispenser,” of which the disclosures are incorporated herein, in their entirety, by reference.

### RELATED APLICATIONS

Commonly owned U.S. Patents and Patent Application Publications include:

U.S. Patent Application Publication No. 2007/0271944, titled “Reduced Calorie Frozen Beverage”;

U.S. Patent Application Publication No. 2003/0224095, titled “Non-Caloric Frozen Carbonated Beverage”;

U.S. Pat. No. 7,870,749, titled “Beverage Dispensing Apparatus and Method for Beverage Dispensing”;

U.S. Patent Application Publication No. 2007/0205220, titled “Juice Dispensing System”;

U.S. Patent Application Publication No. 2007/0267441, titled “Dispenser for Beverages Including Juices”;

U.S. Patent Application Publication No. 2009/0014464, titled “Clean-In-Place System for Beverage Dispensers”;

U.S. Patent Application Publication No. 2012/0228328, titled “Dispenser for Beverages Having a Rotary Micro-Ingredient Combination Chamber”; and

U.S. Patent Application Publication No. 2012/0230148, titled “Dispenser for Beverages Having an Ingredient Mixing Module”.

Each of the above referenced Patent Application Publications and Patents is incorporated by reference, in its entirety, into this disclosure.

### BACKGROUND

Traditional frozen beverage dispensers have been limited to dispensing one or two frozen beverage flavors. A need exists to provide frozen beverage dispensers having the capability to dispense several different frozen beverage flavors while still adhering to, for example, spatial constraints.

### BRIEF DESCRIPTION OF THE DRAWINGS

The accompanying drawings, which are incorporated in and constitute a part of this disclosure, illustrate various embodiments of the present invention. They may not be drawn to scale. In the drawings:

FIG. 1 illustrates one embodiment of a frozen beverage dispenser,

FIG. 2 illustrates another embodiment of the frozen beverage dispenser,

FIGS. 3a-3d illustrate embodiments of a mixing chamber for the frozen beverage dispenser,

FIGS. 4a-4c illustrate additional embodiments of the mixing chamber for the frozen beverage dispenser,

FIG. 5 illustrates another embodiment of the frozen beverage dispenser,

FIGS. 6a-6b illustrate various embodiments of the frozen beverage dispenser,

FIGS. 7a-7b illustrate embodiments of a mixer for the frozen beverage dispenser,

FIGS. 8a-8b illustrate other embodiments of the mixer for the frozen beverage dispenser,

FIG. 9 illustrates another embodiment of the mixer for the frozen beverage dispenser,

FIG. 10 illustrates yet another embodiment of the mixer for the frozen beverage dispenser,

FIG. 11 shows a method consistent with embodiments of the present invention, and

FIG. 12 is a block diagram of a computing device operative to perform the method.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, the location and quantity of parts, and the methods described herein may be modified by substituting, reordering, or adding stages to the disclosed methods. Accordingly, the following detailed description does not limit the invention. Instead, the proper scope of the invention is defined by the appended claims.

Embodiments of the invention may provide a frozen beverage dispenser capable of dispensing multiple frozen beverage flavors. FIG. 1 illustrates one embodiment of a frozen beverage dispenser 100. Frozen beverage dispenser 100 may comprise a frozen carbonated or un-carbonated beverage (FB) barrel 105 for producing and storing a frozen slush or slurry. In some embodiments, the FB barrel 105 may also comprise unflavored water. FB barrel 105 will be described in greater detail with references to FIG. 2-3a. In various embodiments of the invention, the frozen slush may comprise an unflavored or flavorless slush base (i.e. “white paint”). In order to flavor the frozen slush, micro-ingredients and/or macro-ingredients may be mixed in with the frozen slush.

Mixing may occur in a mixing chamber 110 of frozen beverage dispenser 100. Consistent with embodiments of the invention, mixing chamber 110 may comprise, but not be limited to, a macro-ingredient component 115 and a micro-ingredient component 120. The macro-ingredient component 115 may include one or more macro-ingredient cartridges installed therein, each of the cartridges may include a different macro-ingredient. In some embodiments, two or more macro-ingredient cartridges may include the same macro-ingredient. In some embodiments, the macro-ingredient component 115 may receive a macro-ingredient pumped through a line or otherwise delivered to the macro-ingredient component 115 from an external source. Similarly, the micro-ingredient component 120 may include one or more micro-ingredient cartridges installed therein, each of the cartridges may include a different micro-ingredient. In some embodiments, two or more micro-ingredient cartridges may include the same micro-ingredient. In some embodiments, the micro-ingredient component 120 may receive a micro-ingredient pumped through a line or otherwise delivered to the micro-ingredient component 120 from an external source. Macro-ingredients from macro-ingredient component 115 and micro-ingredients from micro-ingredient component 120 may be mixed into the frozen slush by mixer 125. In certain embodiments, mixer 125 may comprise a brushless mixer. However, other mixers may be used. Mixer 125 may be operated by a computing device to produce specified mixtures of frozen slush, macro-ingredients, and/or micro-ingredients. In some embodiments, only micro-ingredients may be added to the frozen slush.

Commonly owned U.S. Patent Application Publication No. 2012/0228328, titled “Dispenser for Beverages Having a Rotary Micro-Ingredient Combination Chamber,” and U.S. Patent Application Publication No. 2012/0230148, titled “Dispenser for Beverages Having an Ingredient Mixing Module,” may disclose mixing, dispensing, and draining methods, systems, and mechanisms that may be adapted into various embodiments of the present invention. Mixing chamber 110 will be described in greater detail with reference to FIGS. 3a-4d.

Once the frozen slush is mixed in with macro-ingredients and/or micro-ingredients to, for example, flavor the frozen slush, the flavored slush may be dispensed from dispensing chamber 130. Even after having dispensed the flavored slush, mixer 125 may still contain residue of the flavored slush. The residue may cause “flavor-carryover” for any subsequent mixtures made by mixer 125. Accordingly, there this residue may be removed from mixer 125 prior to mixing subsequent frozen slush flavors.

Embodiments of the invention may remove the residue by flushing mixer 125 with water, agitating mixer 125, and then using a flush diverter to divert the flushed water to a drain. Commonly owned U.S. Pat. No. 7,870,749, titled “Beverage Dispensing Apparatus and Method for Beverage Dispensing,” U.S. Patent Application Publication No. 2007/0205220, titled “Juice Dispensing System,” U.S. Patent Application Publication No. 2007/0267441, titled “Dispenser for Beverages Including Juices,” and U.S. Patent Application Publication No. 2009/0014464, titled “Clean-In-Place System for Beverage Dispensers,” may disclose mixing, dispensing, and draining methods, systems, and mechanisms that may be adapted into various embodiments of the present invention.

Still consistent with embodiments of the invention, the residue may be removed by running, for a brief period of time, the un-flavored slush base through the mixer 125 without mixing any additional macro-ingredients or micro-ingredients. Mixer 125 may be agitated when the un-flavored slush base is received and then it may dispense the slush into, for example, dispensing chamber 130 or flush diverter 315 as shown in FIG. 3. In this way, the un-flavored slush base serves to flush the residue out of mixer 125. In various embodiments, mixer 125 may not need to be agitated. Rather, gravity may cause the residue within mixer 125 to slide down towards flush diverter 315. Mixer 125 may contain a surface coating, such as, for example, Teflon, to prevent the residue within mixer 125 sticking to the mixer 125. Embodiments of the present invention may further comprise gateway compartment 135. Gateway compartment 135 may serve to channel drainage from the flush diverter 315 to an external system. Moreover, gateway compartment 135 may also channel raw material for producing the frozen slush, macro-ingredients, and micro-ingredients from an external storage to FB barrel 105, macro-ingredient component 115, and micro-ingredient component 120, respectively. In this way, the ingredients needed to produce a frozen slush beverage may be fed into frozen beverage dispenser 100 from a remote location. In addition, though not shown in FIG. 1, embodiments of the present invention may further comprise a storage area attached to the frozen beverage dispenser. The storage area may hold, for example, straws, cups, lids, napkins, and various other accessories that may be useful to a consumer when utilizing or having utilized the frozen beverage dispenser.

FIG. 2 illustrates a front-view of an embodiment of frozen beverage dispenser 100. Consistent embodiments of the invention, frozen beverage dispenser 100 may comprise a touch screen computing device 205. In some embodiments, other forms of user interfaces may be substituted for the touch screen computing device 205. Touch screen computing device 205 may provide frozen beverage flavor selections. When a selection of a flavored frozen beverage is received, touch screen computing device 205 may signal the computing device of mixing chamber 110 with the selection. In various embodiments, the computing device of mixing chamber 110 and the touch screen computing device may be combined into a single computing device. Mixing chamber 110 may then be operated to produce the mixture specified for the selected frozen beverage type.

In this embodiment, the touch screen computing device 205 includes one or more processing units and computer readable media. Computer readable media includes physical memory such as volatile memory (such as RAM), non-volatile memory (such as ROM, flash memory, etc.) or some combination thereof. Additionally, the computing device can include mass storage (removable and/or non-removable) such as a magnetic or optical disks or tape. An operating system, such as Linux or Windows, and one or more application programs can be stored on the mass storage device. The computing devices can include input devices (such as a touch screen, or a keyboard and mouse) and output devices (such as a monitor and printer).

For example, the touch screen computing device 205 can be programmed to receive input from the user. Based upon that input, the touch screen computing device 205 is programmed to execute instructions stored on the computer readable media to control the frozen beverage dispenser 100 to make the desired frozen beverage selected by the user, as described herein. Moreover, in various embodiments, computing device 205 may be configured to interact with a consumer device, such as, for example, a tablet, smartphone, RFID, or any other device capable of communicating via a wireless or wired connection. In some embodiments, a digital barcode displayed on the consumer device may be scanned and read by computing device 105. The digital barcode may reference an online database that stores information associated with the consumer. (In these ways, computing device 205 may be enabled to identify the consumer, store and retrieve previous mixtures dispensed to the consumer, interface with a social media associated with the consumer, and, among other things, accept payment, in electronic form, from the consumer. In addition, the consumer device may be operative to predict which beverage or mixture the consumer would like dispensed from the frozen beverage dispenser based on the consumer's retrieved information (i.e., previous mixtures dispensed to the consumer).

Frozen beverage dispenser 100 may further comprise a first glass window 210 and a second glass window 215. As illustrated in FIG. 2, certain embodiments of the invention may comprise more than one FB barrel. Glass windows 210 and 215 may be included in frozen beverage dispenser 100 to expose the different FB barrels. A FB barrel may be used to produce and store frozen slush from raw materials. The raw materials may comprise water and an additive. The additive may be mixed with the water to minimize any microbiological issues in glass windows 210 and 216 and/or to cause a freezing point depression suitable to produce a desirable consistency in the frozen slush.

Different additives may be used to produce the frozen slush. For instance, sugar or high fructose corn syrup (HFCS) may serve as an additive. Alternatively, a low calorie sweetener may serve as an additive. Consistent with embodiments of the invention, frozen beverage dispenser 100 comprise a first FB barrel having a frozen slush produced with a first additive and a second FB barrel having a frozen slush produced with a second additive. In some embodiments, the first FB barrel may have a nutritive additive with a first caloric value per serving and the second FB barrel may have a non-nutritive or low-nutritive additive with a zero caloric value or a lower caloric value than the first caloric value.

In other embodiments, the FB barrels may have the same acidulant and/or preservative additive(s). In this way, the one barrel may provide the slush and, when emptied, the other barrel, as a backup barrel, may supply the extra slush while the initial barrel is refilling and re-cooling.

In various embodiments, the first FB barrel may be employed to develop slush while the second FB barrel may already have slush to dispense into mixer 125. In this way, the first FB barrel may be producing slush while the second FB barrel may be dispensing slush. Further still, in certain embodiments, different FB barrels may contain different additives and ingredients and, upon command, each may dispense into the mixer. Based on selections received by touch screen computing device 205, a corresponding frozen slush may be produced using the appropriate FB barrel. Commonly owned U.S. Patent Application Publication No. 2007/0271944, titled “Reduced Calorie Frozen Beverage,” and U.S. Patent Application Publication No. 2003/0224095, titled “Non-Caloric Frozen Carbonated Beverage,” may disclose frozen slush production and storage methods, systems, and mechanisms that may be adapted into various embodiments of the present invention.

Frozen beverage dispenser 100 may also comprise a third glass window 220. Third glass window 220 may expose a portion of mixing chamber 110, such as, for example, mixer 125. In this way, an individual may observe his frozen beverage selection as it is mixed before and/or as it is dispensed through dispensing chamber 130. In various embodiments, dispensing chamber 130 may be a remote, counter-top apparatus with corresponding mixing elements located at a remote location. Lines may be connected to such counter-top dispenser to carry the mixed ingredients for dispensing through dispensing chamber 130. The remote location may comprise, for example, FB barrel 105 and mixing chamber 110 and use lines to channel a mixed product to the counter-top dispenser. The counter-top dispenser may be configured to, for example, discard a first portion of the product channeled through the lines through a drain (in order to, for example, discard residue in the lines carried over by the product and warming and melting-to-liquid effect of the products travel). To clean the pipes, a post-rinse solution may be passed through the lines and into a drain once the product is dispensed.

FIG. 3a illustrates an embodiment of mixing chamber 110. FIG. 3b illustrates an embodiment of mixing chamber 110 in a dispense configuration. FIG. 3c illustrates an embodiment of mixing chamber 110 in a flush configuration. FIG. 3d illustrates an embodiment of mixing chamber110 in a recirculate configuration.

Referring to FIG. 3a, FB barrel 105 may receive a water and additive mixture. The interior surface of FB barrel 105 may then be cooled. As the mixture interacts with the cool interior surface of the FB barrel 105, it begins to cool and adhere to the surface. A motorized auger may then scoop the cooled mixture from the interior surface of FB barrel 105 and push it towards the center of FB barrel 105. In this way, the mixture is continuously cooled and mixed into a frozen slush. Other means for producing the frozen slush may be implemented, and the present invention is not limited to the aforementioned frozen slush production process.

The frozen slush produced by FB barrel 105 is passed to the mixer 125. As mentioned above, mixer 125 may be a brushless mixer similar to the ones shown in FIG. 3a. Mixer 125 may also receive ingredients from macro-ingredient component 115 and micro ingredient component 120. Macro-ingredient component 120 may comprise, for example, various cartridges including feeds of HFCS, juice, milk, yogurt, fruit puree, fruit pulp, fruits chunks, and/or various other textural elements. The macro-ingredients may be concentrated ingredients having reconstitution ratios of about 3:1 to about 6:1 or higher. Any number of macro-ingredients may be added to mixer 125 from macro-ingredient component 120.

Micro-ingredient component 120 may be used to flavor the frozen slush. The micro-ingredients may comprise, but not be limited to, for example, cartridges comprising a sweetener, various flavors, teas, coffees, and/or alcohol. From these cartridges, various micro-ingredients may be fed into a ceramic rotary micro-ingredient combination device 310, then subsequently enter mixer 125. In certain embodiments, the combination device may also be used to feed macro-ingredients into mixer 125.

Micro-ingredient component 120 may include cartridges for providing any number of ingredients including, but not limited to, sweetened beverage bases or beverage syrups, sweetened flavors or flavor syrups, unsweetened beverage bases, unsweetened beverage base components (such as the acid, acid-degradable, and non-acid portions of a beverage base), unsweetened flavors, natural and artificial flavors, flavor additives, natural and artificial colors, nutritive or non-nutritive natural or artificial sweeteners, additives for controlling tartness (e.g., citric acid, potassium citrate, etc.) and maintaining slush stability, as well as functional additives such as vitamins, minerals, or herbal extracts, nutraceuticals, or medicaments. The beverage micro-ingredients may have reconstitution ratios from about 10:1, 20:1, 30:1, or higher with many having reconstitution ratios of 50:1 to 300:1. The viscosities of the ingredients at any temperatures may range from about 1 to about 1000 centipoise.

As mentioned above, the frozen slush may be an un-flavored slush base. By adding the mixed micro-ingredients and macro-ingredients (as derived from a selection received at touch screen computing device 205), the otherwise un-flavored slush base may acquire a flavor and texture.

Once the mixed micro-ingredients and/or macro-ingredients are added to the frozen slush, the now flavored frozen slush may be dispensed as illustrated in FIG. 3b via dispensing chamber 130. The residue in mixer 125, leftover from the mixture, may be flushed with an input of water and drained via flush diverter 315 as illustrated in FIG. 3c. Flush diverter 315 may also be configured to flush slush that has melted during the mixing process. In this way, only frozen slush may be dispensed. In other embodiments of the invention, the residue may be flushed from mixer 125 by running the unmixed or pre-mixed frozen slush through mixer 125 for a brief period of time after each dispense. In this way, the residue may be mixed with the frozen slush and subsequently dispensed, thereby cleansing mixer 125 of the residue.

FIG. 4a illustrates another embodiment of mixer 125. Mixer 125 may comprise open trough auger driven mixer 125 receiving feed from FB barrel 105, macro-ingredients component 115, and micro-ingredients component 120. Mixer 125 may be driven by a motor 405. The mixer 125 may be inclined to ensure a thorough mixture of the frozen slush, macro-ingredients and/or micro-ingredients, as the auger rotates to propagate the mixture up through mixer 125. Eventually, the mixture is forced out of mixer 125 and into a funnel 420 leading to dispensing chamber 130. The residue of the mixture may be cleared by spraying water from nozzle 410. The water may run down the mixer and be drained through a drainage tubing 415. Slush that has melted during the mixing process may also be drained through drainage tubing 415 so as not to be dispensed. In this way, only frozen slush may be dispensed. FIGS. 4b and 4c illustrate different embodiments that may be used for the base of the mixer 125. In each of FIGS. 4b and 4c, there is a trough at the bottom of mixer 125 within which the auger is placed. Having a trough at the bottom of the mixing chamber promotes delivery of all of the ingredients to the auger and also promotes thorough mixing of the ingredients together. In some embodiments, the cross-section of mixer 125 may simply be a regular circle or oval. In various embodiments, the auger may comprise, or be in the form of, for example, a stud-like drill. The stud-like drill may contain a rubber clad extending to the sides of mixer 125 to sweep and clean the slush from the wall of mixer 125. In still other embodiments, elements 415 and 420 may be reversed or different (i.e., funnel as 415, drainage tubing as 420, and/or both funnel and drainage tubing as 415 and/or 420).

FIGS. 5-10 illustrate various embodiments of the frozen beverage dispenser and mixer 125. FIG. 5 illustrates one configuration in which the frozen beverage dispenser may comprise a pump-like motor 405 configured to oscillate in and out of mixer 125. The pump-like motor 405 may comprise a syringe-like chamber connected to a bottom portion of mixer 125. The pump may intake the slush from mixer 125 and then output the slush back into mixer 125. In this way, pump-like motor 405 may mix the contents of mixer 125.

FIGS. 6a-6b illustrate embodiments where the mixing of the frozen beverage may occur within a cup 610. For example, as depicted in FIG. 6a, a cup-holder 620 may be configured to keep cup 610 in place while slush and mixers (e.g., the ingredients) are dispensed into cup 610 from mixing chamber 110. Once the ingredients are dispensed, a mixing rod 615 may be lowered into the cup through an opening 605. Motor 405 may then cause mixing rod 615 to rotate and stir the dispensed ingredients within cup 610 for a period of time. In this way, the mixing occurs within the cup, allowing the consumer to view the mixing while it happens within cup 610.

In another embodiment, cup-holder 620 may be configured to lift cup 610 from the dispensing chamber 130 against the bottom of opening 605 of mixing chamber 110. For example, cup-holder 620 may be configured with a lifting mechanism such as, for example, a spring-type or automatic lifter. The lifting mechanism may be operative to lift cup against the bottom of opening 605 of mixing chamber 110, causing an effective seal of opening 605. With cup 610 lifted and placed against the bottom of opening 605 of mixing chamber 110, slush and mixers (e.g., the ingredients) may be dispensed into cup 610. Once the ingredients are dispensed, mixing rod 615 may lower than stir (by operation of motor 405) the dispensed ingredients within cup 610 for a period of time. After mixing is complete, mixing rod 615 may rise back into mixing chamber 110 and cup-holder 620 may lower cup 610 back into dispensing chamber 130 from which a consumer may take cup 610 containing the dispensed and mixed frozen beverage.

FIG. 6b illustrates embodiments where the mixing chamber 110 performs its self-rinsing before the next order. For example, as noted above, the cup-holder 620 may be also configured with a lifting mechanism such as, for example, a spring-type or automatic lifter. After the mixing rod 615 has lifted and cup 610 has been removed, the lifting mechanism may again rise, causing an effective closing hole 605. Then, mixing chamber 110, having opening 605 sealed, may perform a rinsing cycle with a rinse solution. The rinse solution may be discarded through drainer 415.

FIGS. 7a-7b illustrate various embodiments of mixer 125. As depicted in FIG. 7a, motor 405 may operate a mixing rod in a V-shape or conical form 705. Mixing rod 705 may serve to grind the slush materiel and contain various ridges which, when operated by motor 405, stir and mix the contents of mixer 125. FIG. 7b depicts mixer 125 with a pestle rod 710 having a plurality of grooves on its sides. Here, motor 405 may be operative to displace pestle rod 710 vertically as well as rotate pestle rod 710 about its vertical axis. In this way, pestle rod 710 may stir and mix the contents of mixer 125.

We claim:

1. A method comprising:
receiving a frozen slush in a mixing area;
inputting at least one ingredient in the mixing area;
mixing the frozen slush with the at least one ingredient into a mixture; and
dispensing the mixture.

2. The method of claim 1, further comprising channeling the mixture to a remote dispensing area prior to dispensing the mixture.

3. The method of claim 2, further comprising discarding a first portion of the channeled mixture through a flush diverter prior to dispensing the mixture.

4. The method of claim 2, wherein channeling the mixture to the remote dispensing area further comprising channeling the mixture to the remote dispensing area through at least one line.

5. The method of claim 4, further comprising:
rinsing the at least one line with a solution after channeling the mixture, and draining the solution through a drain.

6. The method of claim 1, further comprising:
interfacing with a consumer device;
identifying the consumer associated with the consumer device; and
retrieving information associated with the consumer.

7. The method of claim 6, further comprising:
monitoring at least one of the following: a consumer's eye, a consumer's gesture, and a consumer's voice; and
performing at least one operation when the monitoring detects a command associated with the at least one operation.

8. The method of claim 6, wherein retrieving the information associated with the consumer comprises identifying previous mixtures made for the identified consumer.

9. The method of claim 6, further comprising storing information about the mixture dispensed in a memory location associated with the identified consumer.

10. The method of claim 6, wherein inputting the at least one ingredient in the mixing area comprises inputting the at least one ingredient based on a selection received from the consumer device.

11. The method of claim 1, further comprising, prior to dispensing the mixture, accepting a payment wirelessly from the consumer device.

12. A method comprising:
dispensing a frozen beverage base into a cup;
dispensing at least one mixing ingredient into the cup; and
operating, within the cup, a mixing rod to blend the frozen slush and the at least one ingredient.

13. The method of claim 12, further comprising, prior to operating the mixing rod, lowering the mixing rod into the cup.

14. The method of claim 13, further comprising, after operating the mixing rod, raising the mixing rod out of the cup.

15. The method of claim 14, further comprising prior to operating the mixing rod, raising the cup into a mixing chamber comprising the mixing rod into the cup.

16. The method of claim 13, further comprising, after operating the mixing rod, lowering the cup out of the mixing chamber.

17. The method of claim 12, wherein dispensing the at least one mixing ingredient comprises dispensing at least one of the following: a flavor, an alcohol, and a sweetener to the mixer.

18. The method of claim 12, wherein dispensing the frozen beverage base comprises receiving the frozen beverage base from a frozen beverage barrel.

19. A system comprising:
a memory storage; and
a processing unit coupled to the memory storage, wherein the processing unit is configured to operate:
a mixer, at least one ingredient component for adding at least one ingredient to the mixer,
a dispenser for dispensing a mixed frozen slush, and
a flush diverter for draining at least one of the following: melted slush and water.

20. The system of claim 19, wherein the computing device is further configured to perform at least one of the following:
receive a selection of a frozen slush beverage,
determine when to add the at least one ingredient to the mixer based on the selection,
operate the mixer to mix the at least one ingredient with the frozen slush to form the selected frozen slush beverage,
dispense the frozen slush beverage, and
flush the mixer with water after dispensing the frozen slush beverage,
wherein the water is drained out of the mixer by the flush diverter.

21. The system of claim 20, wherein the computing device being configured to flush the mixer with water after dispensing the frozen slush beverage comprises the computing device being configured to agitate the mixer prior to the flushing the water.

22. The system of claim 19, wherein the computing device is further configured to perform at least one of the following:
receive a selection of a frozen slush beverage,
determine when to add the at least one ingredient to the mixer based on the selection,
operate the mixer to mix the at least one ingredient with the frozen slush to form the selected frozen slush beverage,
dispense the frozen slush beverage, and
run the unmixed frozen slush through the mixer for a brief period of time to flush the mixer.
